(19) United States
(12) Patent Application Publication
(10) Pub. No.: US 2010/0059174 A1
(43) Pub. Date: Mar. 11, 2010

(54) BOROXINE DERIVATIVES AS FLAME RETARDANT

(75) Inventors: Roger Tietze, The Woodlands, TX (US); Dave Orser, Lodi, NJ (US); Yefim Blyakhman, Brooklyn, NY (US); Mark Bryant, The Woodlands, TX (US); Bor-Sheng Lin, Heights, NJ (US); Ulrich Weidmann, Basel (CH)

Correspondence Address: HUNTSMAN ADVANCED MATERIALS AMERICAS LLC, 10003 WOODLOCH FOREST DRIVE, THE WOODLANDS, TX, 77380, US

(73) Assignee: HUNTSMAN ADVANCED MATERIALS AMERICAS INC., THE WOODLANDS (TX)

(21) Appl. No.: 11/816,923

(22) PCT Filed: Feb. 23, 2006
(86) PCT No.: PCT/EP06/60237

§ 371 Date: Jun. 25, 2008

(30) Foreign Application Priority Data
Feb. 25, 2005 (US) 60656802

(51) Int. Cl. C07F 5/05; C08K 5/55; B32B 38/08

(52) U.S. Cl. 156/278; 568/3; 524/183

(57) ABSTRACT

The instant invention relates to boroxine derived compounds, for example tripropargylboroxine, the preparation of said compounds and the use as flame retardant in polymeric resins, in particular in thermosetting polymeric resins.

### TECHNICAL HELD

This invention relates to compounds derived from boroxine, and their use as flame retardant in polymeric resins, in particular in thermosetting polymeric resins.

### BACKGROUND OF THE INVENTION

The flame resistance of polymeric resins, in particular of thermosetting polymeric resins, such as for instance epoxy, benzoxazine, cyanate or polyimide (addition as well as thermoplastic) resins, is still not sufficient for many uses. In order to make polymeric resins flame retardant the addition of bromine, phosphorous or chlorine containing compounds or fillers is necessary. Very often the offered solutions to make a composition flame retardant is based on inert fillers or halogen containing compounds or other additives which have as a rule one or several drawbacks:
They are inert materials not reacting into the system and hence can cause problems in terms of processing.
They lower the thermal performance of the resins.
They may not be soluble in organic solvents.
They often lack flexibility to work in more than one type of resin system.
Toxic gases of combustion may form in case of fire, especially when halogenated compounds are present.

Therefore it is preferred that flame/heat resistant polymeric resins are free of halogen containing compounds.

Boroxines have become known as co-catalysts in the preparation of alkene polymerization catalysts. Mainly trimethoxy boroxines had been used for that purpose, cf. US 20030207757. Those compounds are further known for their ability to capture salt anions cf. EP 898319. Protective coatings by using boron compounds have also been prepared, cf. EP 791029. WO 2003011583 describes a system based on trimethoxyboroxine which is able to increase the interlayer adhesion—U.S. Pat. No. 4,343,928 describes transparency composites including transparent, heat-resistant interlayer formed from epoxy resin, trimethoxyboroxine and phenyl substituted alkyl alcohol, especially benzyl alcohol.

The treatment of wood by using boron compounds which acts also as flame retardants has been described in cf. WO 2002102560.

Boronic acid esters became known as flame retardants, cf. WO 200026288.

Beyond that, trimethoxy boroxines were used in expandable systems, cf. U.S. Pat. No. 5,474,721.

Halo-substituted boroxines have been mentioned as fire retarded compositions, cf. WO 9842802.

### SUMMARY OF THE INVENTION

It now has surprisingly been found that articles made from polymeric resins, in particular from thermosetting polymeric resins, comprising compounds derived from boroxine with at least one boron atom substituted by an oxy derivative of an aliphatic, unsaturated chain such as, for example, tripropargylboroxine may show a greatly reduced flammability while the mechanical and thermal performance is maintained. Such articles are therefore particularly suitable for use in aerospace, industrial, electronics or other applications such as automotive, adhesives, sealants, prepregs and laminates, coatings and PCB's. They can also be processed by using infusion techniques such as RTM (resin transfer moulding) or Vacuum RTM (VaRTM).

### DETAILED DESCRIPTION OF THE INVENTION

An aspect of the present invention is a compound (A) comprising a boroxine cycle wherein at least one of the 3 boron atoms of the cycle bears a substituant comprising an oxy function bonded to (1) the boron atom and to (2) a moeity containing an unsaturated, non-aromatic, carbon-carbon bond. This moeity (2) can also be called an unsaturated, non-aromatic, carbon-carbon bond-containing part.

According to IUPAC rules, an aliphatic compound is an “acyclic or cyclic, saturated or unsaturated carbon compound, excluding aromatic compound”.

Preferably, the substituant an oxy derivative of an unsaturated aliphatic compound.

Preferably, the compound according to the invention is either an alkenoxyboroxine comprising at least one carbon-carbon double bond or, more preferably, an alkynoxyboroxine comprising at least one carbon-carbon triple bond.

Preferably, the substituant has a general formula like;

—O—(CR1R2)n-[C((R3)oR4)≅C((R5)pR6)] wherein

≅ is an unsaturated bond;
n>=0 and, when n>1, R1 and/or R2 can be different on each of the n carbon atoms;
o=p=0 when the unsaturated bond is a triple carbon-carbon bond or o=p=1 when the unsaturated bond is a double carbon-carbon bond;
each of R1 to R6 is independently H, or any other organic or non organic derivative.

Preferably n=1 to 20, preferably n=1

If the substituant is an alkenoxy derivative, it is preferably not chosen amongst the following list: tris(2-propenyloxy)-, tris(3-butenyloxy)t-, tris(2-butenyloxy)-, tris[(2-methyl-2-propenyl)oxy]-, tris[(1-methyl-2-propenyl]oxy]-, tris(4-pentenyloxy)-, tris[(1-methyl-3-butenyl)oxy]-, tris[(1-methyl-2-butenyl)oxy]-, tris[(1-ethyl-2-butenyl]oxy)-, tris(9-octadecenyloxy)-.

Preferably the unsaturated bond of the substituant is close to the boroxine cycle. It is believed that the absence of a long aliphatic chain is in favor of the stability and dispersibility or solubility of the boroxine derivative compound into a resin matrix. Therefore, preferably n=1 when the general formula applies.

The substituant comprises an unsaturated bond which is not part of an aromatic moeity. Without being bond by any theory, the inventors believe that this enables the unsaturated bond to participate in further polymerisation of a resin which enhances the spread of compound (A) throughout the cured resin and may play a role in providing appropriate flame or heat resistance.

Preferably the unsaturated bond of the substituant is a carbon-carbon triple bond.

Preferably, all 3 oxygen atoms of the boroxine cycle are substituted. This ensures that a high rate of unsaturations are available to participate in further resin polymerisation.

Preferably, the substituants on the carbon atoms participating in, or adjacent to the unsaturated bond are all hydrogen. This is believed to participate in appropriate stability of the compound and its dispersibility and compatibility in resins.

Another aspect of the invention is a method of preparation of a compound (A), the method comprising exchanging at least one alkoxy moiety of trialkoxyboroxin with an unsaturated aliphatic alcohol moiety, preferably an alkenyl- or alkynyl alcohol moiety, preferably by heating.

Preferably all 3 alkoxy moeities of trialkylboroxine are exchanged.

A preferred aspect of the present invention is a compound of the formula

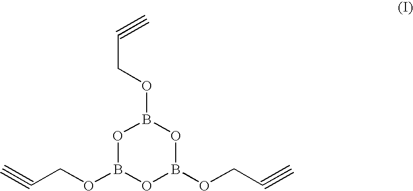

tripropargylboroxine, also called trispropargylboroxine.

A convenient method of preparation of a compound of formula (I) comprises exchanging the alkoxy moieties of trialkoxyboroxin with propargyl alcohol moieties by heating. Preferably, the trialkoxyboroxin and the propargyl alcohol are reacted in a molar ratio of about 1 to 3 with up to 25% by weight of an excess of propargyl alcohol. Preferably, the trialkoxyboroxine is a tri-C₁-C₄-alkoxyboroxine, and most preferred trimethoxyboroxine is used and the resulting methanol is distilled off.

Another aspect of the present invention is the use of a compound (A) in the process of preparation of flame retarded castings, prepregs, laminates or infusion systems which are based on polymeric resins, in particular on thermosetting polymeric resins.

Flame retarded in the context of the present invention means, preferably, meeting the UL 94 standard (“Underwriters Laboratory” test method UL 94) criterion V0.

The properties of the polymeric resins produced as described above can be tailored for the envisaged application by addition of usual additives. The following additives are of particular importance:

Reinforcement fibers, such as glass, quartz, carbon, mineral and synthetic fibers (Keflar, Nomex), natural fibres, such as (flax, jute, sisal, hemp) in the usual forms of short fibers, staple fibers, threads, fabrics or mats;
plasticizers, especially phosphorus compounds;
carbon black or graphite;
fillers;
dyestuffs;
micro hollow spheres;
metal powders.

The processes known for polymeric resins, in particular for thermosetting polymeric resins, such as hot-pressing of prepregs, SMC (Sheet Molding Compound); molding; casting; filament winding; infusion techniques or vacuum impregnating (RTM, VaRTM) are suitable for processing the compositions according to the invention. With respect to vacuum impregnating, very fine additives having a particle size of 0.2 to 0.001 mm are particularly suitable.

The weight of a flame retardant used in a composition will depend upon the effectiveness of that component in the formulation in achieving the desired V0 criterion according to UL-94 standard. A weight range of 0.1 to 50% by weight of compound (A) has to be taken into account, based on the resin composition. A particularly suitable composition comprises more than 1, and more preferably more than 5, % by weight based on the resin composition.

Another aspect of the present invention is a polymeric resin composition, in particular a thermosetting polymeric resin composition, comprising an epoxy, benzoxazine, cyanate or polyimide resin and a compound (A). Suitable compositions may include mixtures of polymeric resins, in particular mixtures of thermosetting polymeric resins.

Typical epoxy resins that are especially useful are bisphenol A and bisphenol F based epoxy resins, epoxy cresol novolac, epoxy phenol novolac and cycloaliphatic epoxy resins. Particularly useful epoxy resins are those commercially available which include, for example, multifunctional epoxy resins (Tactix 742, Tactix 556, and Taxtix 756, PT 810, MY 720 and MY 0500.)

Typical benzoxazine resins that are especially useful are benzoxazines based on bisphenol A and bisphenol F, thiodiphenolbenzoxazines, benzoxazines based on phenolphthalein or having a dicyclopentadiene structure as well as sulfonbenzoxazines. Suitable aldehyde reactants include vaporous formaldehyde; para-formaldehyde; polyoxymethylene; as well as aldehydes having the general formula RCHO, where R is aliphatic, including mixtures of such aldehydes, desirably having from 1 to 12 carbon atoms. Suitable amine reactants require at least one primary amine group. It being also possible that the phenolic compound may have one or more amine substituents.

Typical cyanate resins that are especially useful may be chosen from aryl compounds having at least one cyanate ester group on each molecule and may be generally represented by the formula Ar(OCN)ₘ, where m is an integer from 2 to 5 and Ar is an aromatic radical. The aromatic radical Ar should contain at least 6 carbon atoms, and may be derived, for example, from aromatic hydrocarbons, such as benzene, biphenyl, naphthalene, anthracene, pyrene or the like. The aromatic radical Ar may also be derived from a polynuclear aromatic hydrocarbon in which at least two aromatic rings are attached to each other through a bridging group. Also included are aromatic radicals derived from novolac-type phenolic resins—i.e., cyanate esters of these phenolic resins. The aromatic radical Ar may also contain further ring-attached, non-reactive substituents.

Examples of such cyanate esters include, for instance, 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; bis(4-cyanatophenyl)methane and 3,3′,5,5′-tetramethyl bis(4-cyanatophenyl)methane; 2,2-bis(3,5-dichloro-4-cyanatophenyl) propane; 2,2-bis(3,5-dibromo-4-dicyanatophenyl) propane; bis(4-cyanatophenyl)ether; bis (4-cyanatophenyl) sulfide; 2,2-bis(4-cyanatophenyl) propane; tris(4-cyanatophenyl)-phosphite; tris(4-cyanatophenyl) phosphate; bis(3-chloro-4-cyanatophenyl)methane; cyanated novolac; 1,3-bis[4-cyanatophenyl-1-(methylidene)]benzene and cyanated bisphenol-terminated polycarbonate or other thermoplastic oligomer.

Other cyanate esters include cyanates disclosed in U.S. Pat. Nos. 4,477,629 and 4,528,366, the disclosure of each of which is hereby expressly incorporated herein by reference; the cyanate esters disclosed in U. K. Pat. No. 1,305,702, and the cyanate esters disclosed in International Patent Publication WO 85/02184, the disclosure of each of which is hereby expressly incorporated herein by reference.

Particularly useful cyanate resins are those commercially available which include, for example, bisphenol A based-, bisphenol E based, materials.

Typical polyimide resins of the thermoplastic polyimide type that are especially useful are those of the general formula (1) wherein a is an integer greater than 1, e.g., in the range from about 10 to about 10,000 or more; and V is a tetravalent linker without limitation, as long as the linker does not impede synthesis or use of the thermoplastic polyimide:

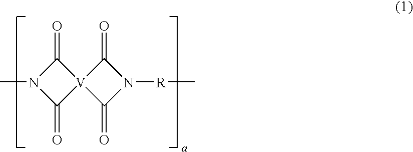

Suitable linkers include but are not limited to: (a) substituted or unsubstituted, saturated, unsaturated or aromatic monocyclic and polycyclic groups having about 5 to about 50 carbon atoms, (b) substituted or unsubstituted, linear or branched, saturated or unsaturated alkyl groups having 1 to about 30 carbon atoms; or combinations thereof. Suitable substitutions and/or linkers include, but are not limited to, ethers, epoxides, amides, esters, and combinations thereof. Preferred linkers include but are not limited to tetravalent aromatic radicals of formula (2), such as

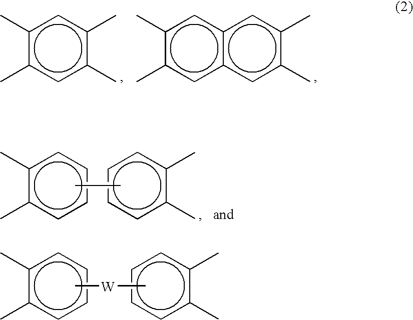

wherein W is a divalent moiety selected from the group consisting of —O—, —S—, —C(O)—, —SO₂—, C_{Y}H_{2Y} (y being an integer from 1 to 5), and halogenated derivatives thereof, including perfluoroalkylene groups, or a group of the formula —O—Z—O— wherein the divalent bonds of the —O— or the —O—Z—O-group are in the 3,3′,3,4′,4,3′, or the 4,4′ positions, and wherein Z includes, but is not limited, to divalent radicals of formula (3).

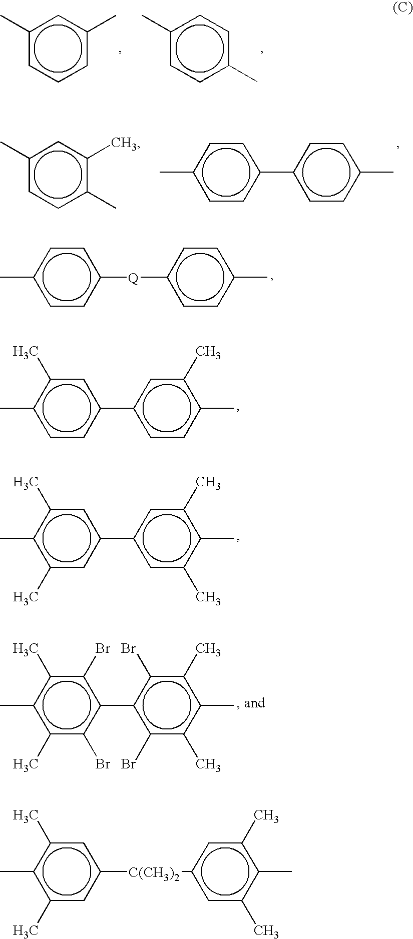

wherein Q includes but is not limited to a divalent moiety selected from the group consisting of —O—, —S—, —C(O)—, —SO₂—, C_{y}H_{2y} (y being an integer from 1 to 5), and halogenated derivatives thereof, including periluoroalkylene groups.

R in formula (1) includes but is not limited to substituted or unsubstituted divalent organic radicals such as: (a) aromatic hydrocarbon radicals having about 6 to about 20 carbon atoms and halogenated derivatives thereof; (b) straight or branched chain alkylene radicals having about 2 to about 20 carbon atoms; (c) cycloalkylene radicals having about 3 to about 20 carbon atoms, or (d) divalent radicals of the general formula (4)

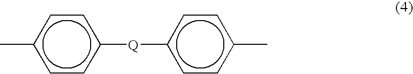

wherein Q is as defined above.

Particularly useful polyimide resins are bismaleimide resins, especially those which include, for example 4, 4′-Methylene-bis-(N-phenyl-maleimide) and advancements of 4,4′-Methylene-bis-(N-phenyl-maleimide) and diallyl bisphenol A (allyl group in ortho position to the phenolic OH).

Beyond this, it is possible to incorporate fillers like ammonium polyphosphates and inorganic and organic phosphorus compounds as described in EP 356379 and U.S. Pat. No. 5,200,452.

In another aspect, the invention provides an article obtained by curing a polymeric resin composition comprising an epoxy, benzoxazine, cyanate or polyimide resin and a compound (A).

In another aspect, the invention relates to boroxine derived compounds, for example tripropargylboroxine, the preparation of said compounds and the use as flame retardant in polymeric resins, in particular in thermosetting polymeric resins.

The compositions are particularly useful to make electrical laminates and other composites from fibrous reinforcement and a matrix resin. Examples of suitable processes usually contain the following steps:

### Solvent Based Impregnation Process

(1) A polymer resin formulation is applied to or impregnated into a substrate by rolling, injection, dipping, spraying, other known techniques and/or combinations thereof. The substrate is typically a woven or nonwoven fiber mat containing, for instance, glass fibers or paper.

(2) The impregnated substrate is “B-staged” by heating at a temperature sufficient to draw off solvent in the polymer resin formulation and optionally to partially cure the polymer resin formulation, so that the impregnated substrate can be handled easily. The “B-staging” step is usually carried out at a temperature of from 90° C. to 210° C. and for a time of from 1 minute to 15 minutes. The impregnated substrate that results from “B-staging” is called a “prepreg”. The temperature is most commonly 100° C. for composites and 130° C. to 200° C. for electrical laminates.

(3) One or more sheets of prepreg are stacked or laid up in alternating layers with one or more sheets of a conductive material, such as copper foil, if an electrical laminate is desired.

(4) The laid-up sheets are pressed at high temperature and pressure for a time sufficient to cure the resin and form a laminate and to remove air and solvents. The temperature of this lamination step is usually between 100° C. and 250° C., and is most often between 165° C. and 200° C. The lamination step may also be carried out in two or more stages, such as a first stage between 100° C. and 150° C. and a second stage at between 165° C. and 200° C. The pressure is usually between 50 N/cm² and 500 N/cm². The lamination step is usually carried out for a time of from 1 minute to 200 minutes, and most often for 45 minutes to 90 minutes. The lamination step may optionally be carried out at higher temperatures for shorter times (such as in continuous lamination processes) or for longer times at lower temperatures (such as in low energy press processes).

(5) Optionally, the resulting laminate, for example, a copper-clad laminate, may be post-treated by heating for a time at high temperature and ambient pressure. The temperature of post-treatment is usually between 120° C. and 250° C. The post-treatment time usually is between 30 minutes and 16 hours.

### EXAMPLES

All tests are performed according to IPC TM 650.
The IPC test methods are the electrical laminate industry standard (The Institute For Interconnection and Packaging Electronic Circuits, 3451 Church Street, Evanston, Ill. 60203) as follows:

| Method | IPC-Test Method Number: |
|---|---|
| Reactivity (varnish) | IPC-TM-650-5.410 |
| Rest Gel time at 170° C., seconds | IPC-TM-650-2.3.18 |
| Mil Flow, weight percent | IPC-TM-650-2.3.17 |
| Glass Transition Temp., T_{g} [° C.] | IPC-TM-650-2.4.25 |
| Copper Peel Strength | IPC-TM-650-2.4.8 |
| Pressure Cooker Test, weight | IPC-TM-650-2.6.16 |
| percent water pick-up & percent | |
| passed solder bath at 260° C. | |
| UL-94 Standard | IPC-TM-650-2.3.10 |

### A) Preparation of Tripropargylboroxine (Compound (I))

A mixture of 3 moles of propargyl alcohol and 1 mole of trimethoxyboroxine are heated to a temperature of 120-150° C. until distillation of methanol stops.

Boiling point: 85-88° C. (at 10 mm Hg column pressure)

### B) Laminates

Fiberglass laminate composites are made by the solvent impregnating process. The components are dissolved in a solvent and then coated onto 7628 fabrics, an industry standard fiberglass weave type as defined by the glass strands, thickness and weight of the glass weave (Porcher SA 7628; with a silane or polyimide finish). The solvent is then evaporated and the composition B-staged. The prepreg with copper is then laminated under heat and pressure to produce a copper clad laminate (Table 3). The temperature of the hot air in the oven is 150-180° C. and the times to generate the B-stage range in-between 2-5 seconds. The resin content ranges in-between 35-42%. Those laminates are then evaluated for their thermal and flammability properties.

All properties are based on 8 plies 7628 glass fabric laminate as per IPC TMI 3949. The laminates always have the fiberglass plies oriented such that all plies are laid in the same fill and warp direction.

TABLE 2
Laminating Compositions:

| | A | B | C | D | E |
|---|---|---|---|---|---|
| 4,4′-Methylene-bis-(N-phenyl- | 35.32* | 33.24* | 29.44* | 60.2 | 58.22 |
| maleimide) | | | | | |
| Diallyl bisphenol A | 26.93* | 25.35* | 22.45* | 38.1 | 36.77 |
| Thiocyanuric acid | 0.5 | 0.56 | 0.5 | 0.5 | 0.5 |
| Phenothiazine | | 1.6 | 1.4 | 1.7 | |
| TetrabrombisphenolA | 9.85 | | | | |
| (Polycarbonat) Oligomer | | | | | |
| Compound (I) | | 18.9 | 28.5 | | 5.01 |

“bold”: according to the instant invention
*advancement resin based on 4,4′-Methylene-bis-(N-phenyl-maleimide) and Diallyl bisphenol A

TABLE 3

| | |
|---|---|
| Initial Press Temperature | room temperature |
| Heating rate, ° C./min | 3-5 |
| Pressure, psi | 50 |
| Final Press Temperature | 218° C. |
| Time at press temperature | 120 minutes |
| Post cure [2 hours] | 218° C. |

TABLE 4

| Properties | A | B | C | D | E |
|---|---|---|---|---|---|
| Glass | 240-250 | 277.5 | 219.3 | 236.0 | 272. |
| Transition | | | | | |
| Temperature | | | | | |
| [° C.] | | | | | |
| CTE [ppm ° C.] | 20-80 | 50.4 | 18.6 | 35.5 | 59.4 |
| T288 [min] | >60 | >60 | 20.0 | >60 | >60 |
| Decomposition | 330-360 | 407.0 | 373 | 407 | 433. |
| Onset [° C.] | | | | | |
| Weight loss | 1-2 | 3.16 | 2.75 | 0.71 | 1.97 |
| [%] | | | | | |
| (Burning | V0 | V0 | V0 | V1 | V0 |
| behaviour) | | | | | |
| Total burn | 15-30 | 13.6 | 10.1 | 84.2 | 48 |
| time [s] | | | | | |

“bold” according to instant invention

1. A compound comprising a boroxine cycle wherein at least one of the 3 boron atoms of the cycle bears a substituant comprising an oxy function bonded to (1) the boron atom and to (2) an unsaturated, non-aromatic, carbon-carbon bond containing part.

2. The compound according to claim 1, which contains an alkynoxy or
an alkenoxy substituant.

3. The compound according to claim 1, which is tripropargylboroxine of the formula

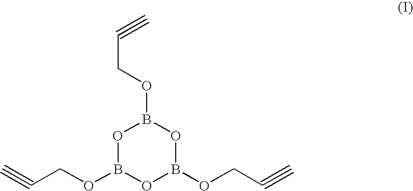

4. A method of preparation of a compound according to claim 1, comprising exchanging at least one alkoxy moiety of alkoxyboroxine with an unsaturated aliphatic alcohol moiety by heating.

5. A method of preparation according to claim 4, comprising exchanging the 3 alkoxy moieties of trialkoxyboroxine with propargyl alcohol moieties by heating so as to form tripropargylboroxine.

6. The method of preparation according to claim 5, wherein the trialkoxyboroxine and propargyl alcohol are reacted in a molar ratio of about 1 to 3 with up to 25% by weight of an excess of propargyl alcohol.

7. The method of preparation according to claim 5, wherein the trialkoxyboroxine is a tri-C₁-C₄-alkoxyboroxine.

8. (canceled)

9. A polymeric resin composition comprising an epoxy, benzoxazine, cyanate or polyimide resin and a compound comprising a boroxine cycle wherein at least one of the boron atoms bears an alkenoxy or an alkynoxy substituent.

10. The composition according to claim 9 comprising 0.1 to 50% by weight of a compound comprising a boroxine cycle wherein at least one of the boron atoms bears an alkenoxy or an alkynoxy substituent.

11-12. (canceled)

13. An article obtained by curing a polymeric resin composition according to claim 9.

14. A method of preparing a laminate comprising the steps of:
i) applying a polymeric resin composition according to claim 9 to a substrate;
ii) heating the substrate at a temperature of from 90° to 210° C. to form prepreg;
iii) laying up one or more sheets of prepreg in alternating layers with one or more sheets of conductive material;
iv) pressing the laid up sheets at a temperature between 100° to 250° C. and a pressure between 50 N/cm² to 500 N/cm² to form the laminate; and
v) optionally, post treating the laminate at a temperature between 120° to 250° C.

15. The method according to claim 14, wherein the substrate is a woven or nonwoven fiber mat.
